(19) United States
(12) Patent Application Publication
(10) Pub. No.: US 2015/0012597 A1
(43) Pub. Date: Jan. 8, 2015

(54) RETROACTIVE MANAGEMENT OF MESSAGES

(71) Applicant: International Business Machines Corporation, Armonk, NY (US)

(72) Inventors: Shiva R. Dasari, Austin, TX (US); Joshua H. Israel, Austin, TX (US); Karthik Kolavasi, Austin, TX (US)

(21) Appl. No.: 13/935,454

(22) Filed: Jul. 3, 2013

(51) Int. Cl. H04L 12/58

(52) U.S. Cl. CPC H04L 51/36
USPC 709/206

(57) ABSTRACT

Embodiments of the present invention provide a method, system and computer program product for retroactive message management. In an embodiment of the invention, a method for retroactive message management is provided. The method includes receiving a message in a messaging client executing in memory of a computer and characterizing the received message. The method also includes identifying an already received message in the messaging client that matches the characterization of the received message. Finally, the method includes processing the identified already received message in response to the receipt of the characterized message, for example by deleting the identified already received message or by moving the identified already received message to a folder in a messaging data store of the messaging client.

### BACKGROUND OF THE INVENTION

1. Field of the Invention

The present invention relates to automated task management and more particularly to automated handling of received messages.

2. Description of the Related Art

Task automation refers to the automated performance of different operations in order to achieve a task. Originally akin to “macro” processing, task automation involved the end user specifying a selection of operations or keystrokes in an application and storing the selection as a macro. Thereafter, the activation of the macro resulted in the automated execution of the selected operations or keystrokes as if those selected operations or keystrokes were input manually in sequence by an end user. Subsequent advancements in task automation have resulted in separate applications able to access both the event queue for an operating system and also the application programming interface (API) of a co-existing application in the operating system. As such, one or more operations present in the API of the co-existing application can be triggered in response to the detection of an event in the event queue of the operating system.

Task automation finds particular application in the field of electronic messaging and specifically within e-mail communications. In a modern e-mail client, the end user is able not only to set automated tasks resulting from the receipt of an e-mail message, but the end user is able to do so both on the client side and also the server side so that the automated tasks are triggered irrespective of the particular e-mail client used to access the e-mail server. The tasks available for automation include primarily the manipulation of the received e-mail message triggering the automated task or tasks, including the forwarding or creating of a new e-mail message. Further, the automated tasks can be triggered not only based upon the source of the e-mail message, but also based upon the context of the received e-mail message such as keywords contained in any field of the e-mail message or the time of day or day of the week when the e-mail message is received.

Yet, automated processing of inbound messages does not account for the circumstance where already received e-mail messages are to be managed. For instance, for many e-mail users, much time is consumed managing an e-mail inbox to delete already received, but unneeded e-mail messages. “Newsletter” e-mails are one such type of e-mail message that are received daily and accumulate rapidly filling a messaging database in no time. However, there is no sense in preserving a week old “Newsletter” e-mail message, when the latest e-mail message of a “Newsletter will suffice.

### BRIEF SUMMARY OF THE INVENTION

Embodiments of the present invention address deficiencies of the art in respect to e-mail message management for already received e-mail messages and provide a novel and non-obvious method, system and computer program product for retroactive message management. In an embodiment of the invention, a method for retroactive message management is provided. The method includes receiving a message in a messaging client executing in memory of a computer and characterizing the received message. The method also includes identifying an already received message in the messaging client that matches the characterization of the received message. Finally, the method includes processing the identified already received message in response to the receipt of the characterized message, for example by deleting the identified already received message or by moving the identified already received message to a folder in a messaging data store of the messaging client.

In another embodiment of the invention, a messaging data processing system is configured for retroactive message management. The system includes a computer with at least one processor and memory and a retroactive message management module coupled to the computer and executing in the memory. The module includes program code enabled to respond to received message in a messaging client by characterizing the received message, identifying an already received message in the messaging client that matches the characterization of the received message, and processing the identified already received message in response to the receipt of the characterized message.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for retroactive message management;

FIG. 2 is a schematic illustration of a messaging data processing system configured for retroactive message management; and,

FIG. 3 is a flow chart illustrating a process for retroactive message management.

### DETAILED DESCRIPTION OF THE INVENTION

Embodiments of the invention provide for retroactive message management. In accordance with an embodiment of the invention, in response to the receipt of a message in a messaging client, a characteristic of the message can be determined and other messages already received in the messaging client that share the determined characteristic can be selected for additional processing. The additional processing can include the deletion of the selected messages, the archiving of the selected messages, or the movement of the selected messages to a folder. In this way, and in particular in the circumstance where the received message is a newsletter, earlier received messages which include earlier versions of the newsletter can be removed from a messaging inbox in favor of the received message so as to not burden the end user with processing multiple versions of the same newsletter.

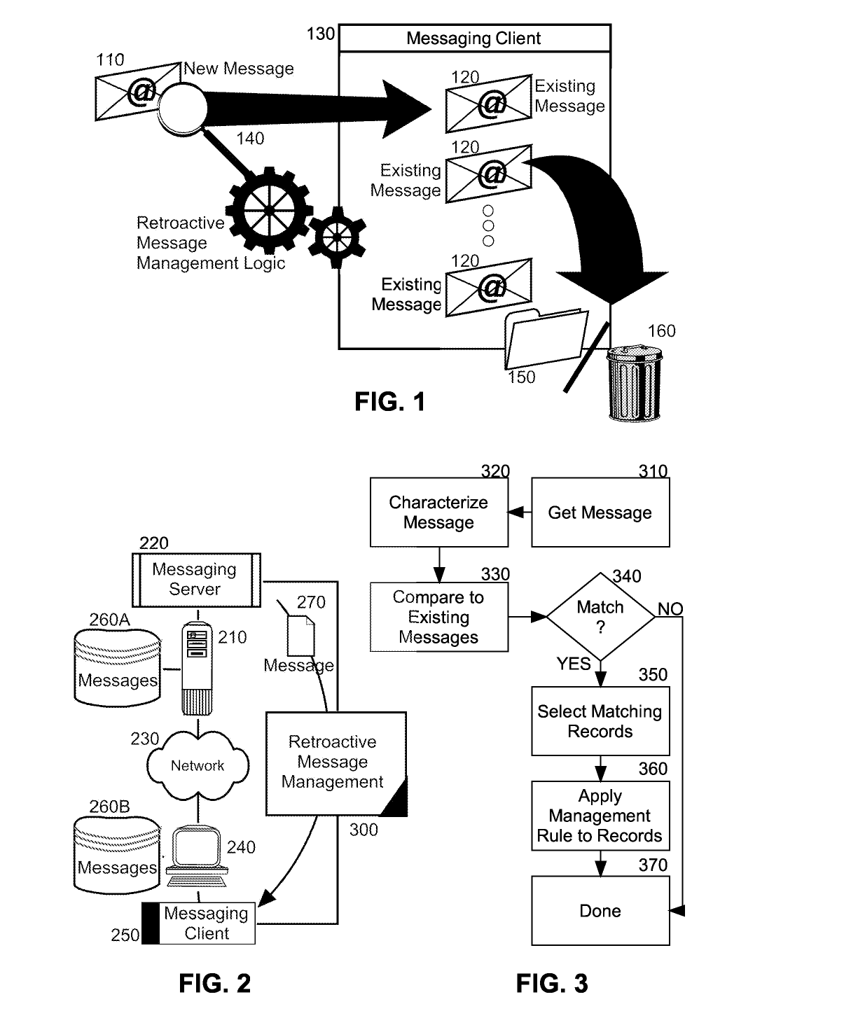

In further illustration, FIG. 1 pictorially shows a process for retroactive message management. As shown in FIG. 1, a message 110 can be received for rendering in a messaging client 130. Retroactive message management logic 140 can determine one or more characteristics of the received message 110 and can match those characteristics to one or more existing messages 120 already received in the messaging client 130. Thereafter, the retroactive message management logic 140 can manage those of the existing messages 120 with characteristics that match those of the received message 110. In this regard, the retroactive message management logic 140 can move the existing messages 120 with characteristics that match those of the received message 110 to a selected folder 150 of the messaging client 130, or those existing messages 120 can be marked for deletion and moved to the “trash” folder 160.

The process described in connection with FIG. 1 can be implemented within a messaging data processing system. In yet further illustration, FIG. 2 schematically shows a messaging data processing system configured for retroactive message management. The system can include a host server computing system 210 that includes one or more server computers each with a processor and memory. The host server computing system 210 can support the operation of a messaging server 220 and can be configured for communicative coupling over computer communications network 230 to a client computer 240 with memory and at least one processor and supporting the operation of a messaging client 250.

The messaging server 220 can include a messaging data store 260A in which different messages can be stored. Likewise, the messaging client 250 can include a messaging data store 260B into which different messages can be stored. In either circumstance, one or more folders can be established in the messaging data stores 260A, 260B into which different messages can be organized. Messages can be sent by way of the computer communications network 230 and received in the messaging server 220. Subsequently, the received messages can be provided for viewing in the messaging client 250 and stored in a folder of one or both of the messaging data stores 260A, 260B.

Of note, retroactive message management module 300 can be coupled to either or both of the messaging server 220 and the messaging client 250. The module 300 can include program code enabled upon execution in memory of a computer to respond to the receipt of a message 270 by determining one or more characteristics of the message 270 such as a subject, sender or one or more terms in the body of the message 270. Thereafter, one or more messages already stored in the messaging data stores 260A, 260B can be compared to the determined characteristics so as to identify related ones of the already stored message.

The determined characteristics can include, for instance one or more already stored messages sharing similar content in each subject line of each of the already stored messages, a shared identity of a sender, shared content in the body of each message, a common message date, or a common message size, a time of the message, an attachment size, a number of attachments, and names on a carbon copy list, or any combination thereof. For example; an existing message in an inbox that matches a set conditions of “Greater than size X” AND “From Sender Y” OR NOT “After Date Y” are deleted upon receiving a new message that matches the same criteria. As another alternative, the determined characteristics can include a shared domain name of an e-mail address of a sender of the message and that of the existing messages.

Finally, those of the identified related ones of the already stored messages can be managed as a group, for instance by deleting the identified related ones of the already stored messages, or by moving the identified related ones of the already stored messages to a folder in the messaging data stores 260A, 260B.

In even yet further illustration of the operation of the retroactive message management module 300, FIG. 3 is a flow chart illustrating a process for retroactive message management. The process can begin in block 310 with the receipt of a message such as an e-mail message. In block 320, the received message can be characterized, for instance according to one or more terms in a subject field of the received message, a sender of the received message, or one or more terms of the body of the received message. In block 330, the characterization of the received message can be compared to a characterization of one or more already received messages and in decision block 340, it can be determined whether or not the characterization of the received message matches a characterization of one or more already received messages.

In decision block 340, if it is determined that the characterization of the received message matches a characterization of one or more already received messages, in block 350, the matching ones of the already received messages can be selected for group management and in block 360, one or more management rules can be applied to the selected messages. For example, the rules can specify that selected messages are to be deleted, or moved to a particular folder in fixed storage. Finally, in block 370 the process can end.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for retroactive message management, the method comprising:
receiving a message in a messaging client executing in memory of a computer;
characterizing the received message;
identifying an already received message in the messaging client that matches the characterization of the received message; and,
processing the identified already received message in response to the receipt of the characterized message.

2. The method of claim 1, wherein the processing includes deleting the identified already received message.

3. The method of claim 1, wherein the processing includes moving the identified already received message to a folder in a messaging data store of the messaging client.

4. The method of claim 1, wherein the characterization of the received message is a set of words in a subject line of the received message.

5. The method of claim 1, further comprising:
identifying additional already received messages in the messaging client each matching the characterization of the received message; and,
processing the identified additional already received messages along with the identified already received message in response to the receipt of the characterized message.

6. The method of claim 1, wherein the message is an e-mail message.

7. The method of claim 1, wherein the message is characterized according to one of an identity of a sender of the message, content of a body of the message, a date of the message, a size of the message and a subject of the message.

8. A messaging data processing system configured for retroactive message management, the system comprising:
a computer with at least one processor and memory;
a retroactive message management module coupled to the computer and executing in the memory, the module comprising program code enabled to respond to received message in a messaging client by characterizing the received message, identifying an already received message in the messaging client that matches the characterization of the received message, and processing the identified already received message in response to the receipt of the characterized message.

9. The system of claim 8, wherein the processing includes deleting the identified already received message.

10. The system of claim 8, wherein the processing includes moving the identified already received message to a folder in a messaging data store of the messaging client.

11. The system of claim 8, wherein the characterization of the received message is a set of words in a subject line of the received message.

12. The system of claim 8, wherein the program code of the module further responds to the received message by identifying additional already received messages in the messaging client each matching the characterization of the received message, and by processing the identified additional already received messages along with the identified already received message in response to the receipt of the characterized message.

13. The system of claim 8, wherein the message is an e-mail message.

14. A computer program product for retroactive message management, the computer program product comprising:
a computer readable storage medium having computer readable program code embodied therewith, the computer readable program code comprising:
computer readable program code for receiving a message in a messaging client executing in memory of a computer;
computer readable program code for characterizing the received message;
computer readable program code for identifying an already received message in the messaging client that matches the characterization of the received message; and,
computer readable program code for processing the identified already received message in response to the receipt of the characterized message.

15. The computer program product of claim 14, wherein the processing includes deleting the identified already received message.

16. The computer program product of claim 14, wherein the processing includes moving the identified already received message to a folder in a messaging data store of the messaging client.

17. The computer program product of claim 14, wherein the characterization of the received message is a set of words in a subject line of the received message.

18. The computer program product of claim 14, further comprising:
computer readable program code for identifying additional already received messages in the messaging client each matching the characterization of the received message; and,
computer readable program code for processing the identified additional already received messages along with the identified already received message in response to the receipt of the characterized message.

19. The computer program product of claim 14, wherein the message is an e-mail message.

20. The computer program product of claim 13, wherein the message is characterized according to one of an identity of a sender of the message, content of a body of the message, a date of the message, a size of the message and a subject of the message.
